(19) United States
(12) Patent Application Publication
(10) Pub. No.: US 2020/0106346 A1
(43) Pub. Date: Apr. 2, 2020

(54) ALTERNATOR VOLTAGE DIGITAL REGULATOR WITH NFC TECHNOLOGY

(71) Applicant: MOTEURS LEROY-SOMER, Angouleme Cedex 9 (FR)

(72) Inventors: Emile Mouni, Angouleme (FR); Christophe MONCHÃTRE, Jarnac (FR); David Richard, Saint Yrieix (FR); Samuel Moser, Gond-Pontouvre (FR)

(21) Appl. No.: 16/469,274

(22) PCT Filed: Dec. 14, 2017
(86) PCT No.: PCT/EP2017/082847

§ 371 Date: Jun. 13, 2019

(30) Foreign Application Priority Data
Dec. 19, 2016 (FR) 16 62744

(51) Int. Cl. H02K 11/35; H02K 7/18; H04Q 9/00

(52) U.S. Cl. CPC H02K 11/35; H02K 7/1815; H04Q 2209/40; H02K 2211/03; H04Q 9/00

(57) ABSTRACT

An electronic apparatus for a rotating electric machine, notably an alternator voltage regulator or speed variator, including an electronic circuit and a wired bus allowing the exchange of information with the outside, such that the bus is defined by an interface module rigidly fixed to a board of the electronic circuit and communicating via a wireless link with the latter.

The present invention relates to the electronic apparatus used for the control and/or the regulation of electrical rotating machines, and notably but not exclusively to an alternator digital voltage regulator.

NFC technology is a radiofrequency contactless communications technology complying with various standards such as CEI-18000-3, ISO/CEI 14443 and CEI 18092, which is very widespread in the field of telephony, notably mobile, and also that of payment and transport cards.

The fields of applications of NFC technology are varied and several problem areas have been addressed in order to render this technology ever more robust and reliable. However, in the field of rotating electrical machines, notably of low or medium voltage alternators, this technology remains very seldom used.

An alternator is a rotating machine designed to be connected to a load or to the electrical line supply. Conventionally, its output parameters, such as the current or the voltage, are controlled by a voltage regulator via the adjustment of the excitation current of the exciter inductor. The excitation current allows a voltage to be created in the exciter armature which is rectified via a rotating diode bridge in order to supply power to the rotating exciter of the main machine. As a result, the rotating exciter becomes the source of a magnetic flux sensed by the main winding of the stator so as to generate the output signal required by the load or the line supply.

The known alternator digital voltage regulators are communicating modules using for example a port of the USB, CANBUS, Ethernet type for exchanging data with the outside, etc. The safety rules in this field impose a level of isolation sufficient to protect the user connecting to the digital regulator, when the alternator is in operation. This complicates the fabrication of the regulator and increases its cost.

There is accordingly a need for further improvement of voltage regulators and other communicating devices equipping rotating electric machines, in order notably to simplify their fabrication while at the same time offering the required protection for the user.

The invention meets this need by virtue of a communicating electronic apparatus for rotating electric machines, notably an alternator voltage regulator or a speed variator, comprising an electronic circuit and a wired port allowing the exchange of information with the outside, characterized in that the wired port is defined by an interface module rigidly fixed to a board of the electronic circuit and communicating via a wireless link with the latter.

By virtue of the wireless communication within the apparatus itself, the invention allows the aforementioned constraints of physical isolation to be overcome while at the same time guaranteeing the required level of safety.

The electric machine may be an alternator.

The regulator may notably provide the protection of the alternator against potential malfunctions such as overloads and over-excitation which can lead to the destruction of the alternator.

The apparatus may be configured to allow the locking of the data by password, in order to render the accessible data secure and to ensure protection of the regulator by means of an access by security code specific to the apparatus.

The board may be accommodated within an outer shell, notably made of thermoplastic material, potentially reinforced, and the interface module then preferably comprises a housing fixed onto this outer shell. The board may be buried in a resin poured into the outer shell.

The housing of the interface module may be fixed by any means onto the board or the aforementioned outer shell. Preferably, the housing of the interface module comprises pins engaged into corresponding holes of the outer shell, notably riveted into these holes. The latter may be formed on a rim of the outer shell.

The interface module communicates with a communications module of the apparatus. Preferably, the board comprises an antenna connected to this communications module and the interface module comprises an antenna disposed facing the antenna of the board.

Preferably, the interface module and the communications module are of the NFC type. This allows components dedicated to this type of technology to be used and advantage to be taken of a high reliability of communication between the interface module and the communications module, despite the surrounding electromagnetic fields.

The interface module comprises at least one connector allowing the connection of a cable, connected for example to a computer, notably of the USB type.

The apparatus, notably the alternator digital voltage regulator, may comprise a main microcontroller whose DC electrical power supply may be via a cable connected to the interface module, notably a cable connected to a computer, or via the voltage produced by the machine equipped with the apparatus, notably when this machine is an alternator.

When the electric machine is an alternator, and the apparatus a regulator, the latter may be configured for transmitting to external equipment, notably a computer, via the interface module, information coming from sensors connected to the alternator, notably data relating to the temperature, the vibration, the current and the excitation voltage, and in particular, all the electrical parameters of the alternator.

The aforementioned board of the apparatus may comprise an additional antenna allowing, when short-circuited, the electromagnetic field sensed by the antenna used for the exchange of data with the interface module to be canceled. This can prevent the reception of data and the powering of the apparatus by the communications module during transition phases where it goes from being powered by the communications module to being powered by the electric machine.

A further subject of the invention is a method for exchanging data with an electronic apparatus according to the invention, equipping a rotating electric machine, notably for configuring it, controlling it and recording information contained in the apparatus or updating the firmware of the apparatus, in which a computer is connected by means of a cable to the interface module and data are exchanged with the apparatus via the interface module.

During this connection, the electric machine may be on or off. If it is off, the interface module can send energy via the coupling of the antennas to the apparatus, and thus allow a main microcontroller of the apparatus to operate despite the machine being off.

According to one feature of a preferred embodiment, the additional antenna is short-circuited during a transient phase, during which the apparatus receives the energy transmitted by the interface module connected to the computer and during which the voltage of the alternator increases but remains insufficient to take over from the power supply via the interface module. This allows a flexible transition between the two power supply sources of the apparatus.

Yet another subject of the invention is a rotating electric machine, notably an alternator, equipped with an apparatus according to the invention, notably serving as a digital voltage regulator for the alternator.

Other features and advantages of the present invention will become apparent from reading the description that follows of non-limiting examples of implementation of the latter, and upon examining the appended drawing, in which:

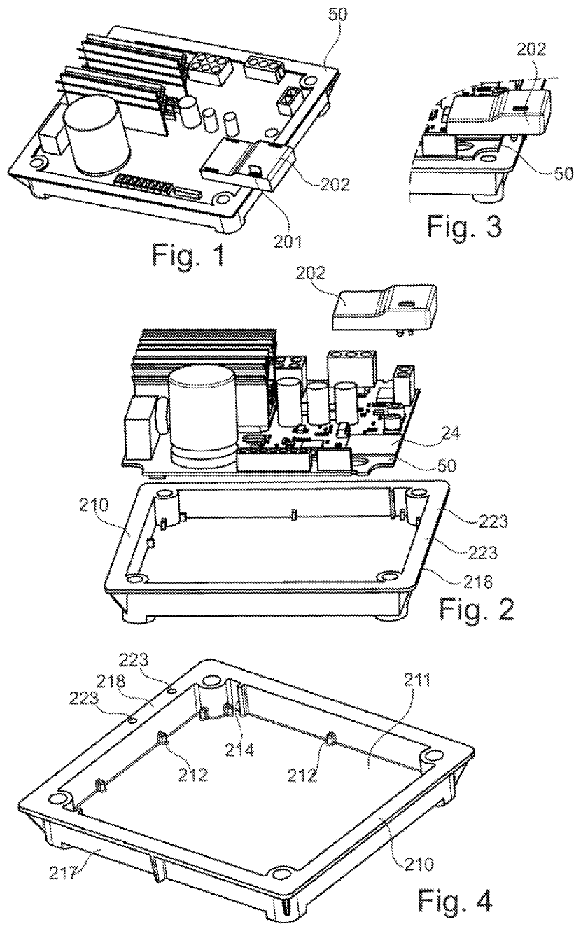

FIG. 1 is a schematic perspective view of the electronic circuit of one example of an apparatus according to the invention,

FIG. 2 is an exploded view of the circuit in FIG. 1,

FIG. 3 shows a detail of the mechanical cooperation between the interface module and an outer shell for accommodating the printed circuit board,

FIG. 4 shows the outer shell in FIG. 3 on its own,

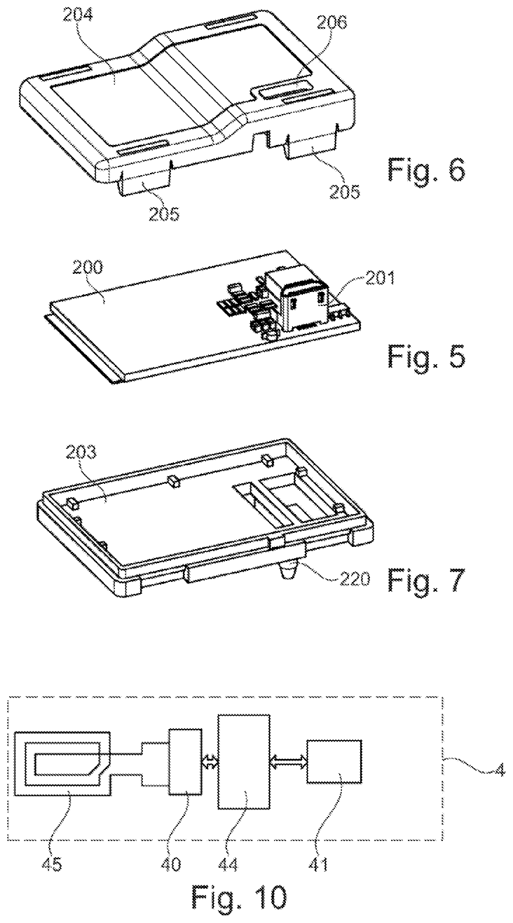

FIGS. 5 to 7 show elements composing the interface module,

FIG. 8 is an electrical circuit diagram of a rotating machine equipped with an apparatus according to the invention,

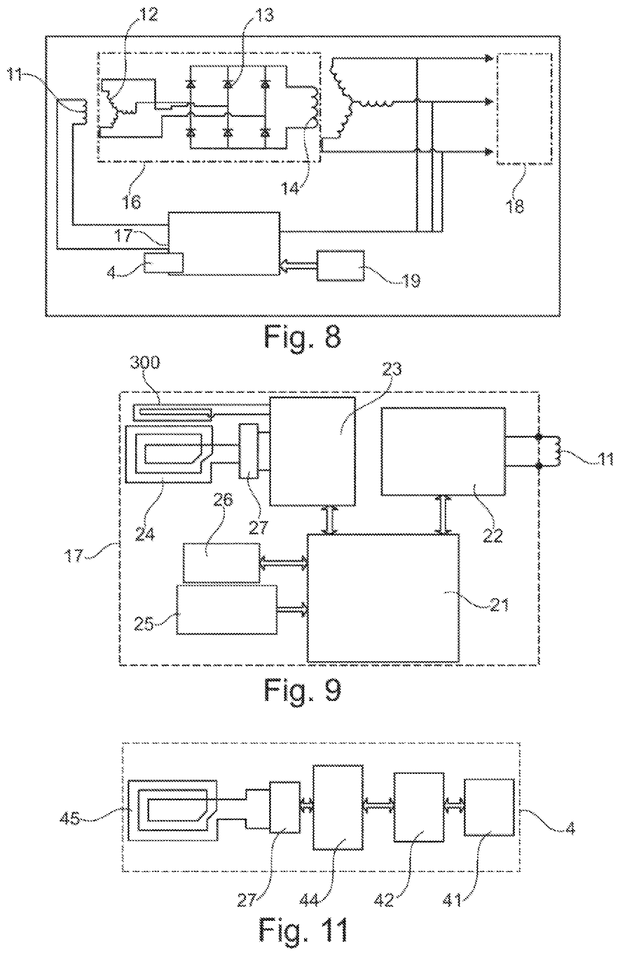

FIG. 9 shows a detail of the circuit diagram in FIG. 8,

FIG. 10 is an electrical circuit diagram of the interface module, and

FIG. 11 is a view analogous to FIG. 10, of one variant embodiment of the interface module.

FIG. 8 shows the circuit diagram of a rotating electric machine equipped with a communicating apparatus 17, in this case a digital voltage regulator, according to the invention.

In the present example, the rotating machine is an alternator designed to be connected to a load or to the electrical line 18.

Its output parameters such as the current or the voltage are controlled by the voltage regulator 17 through the adjustment of the excitation current of the exciter inductor 11. The excitation current allows a voltage to be created in the exciter armature 12 which is rectified via a rotating diode bridge 13 in order to power the rotating exciter 14 of the main machine. Accordingly, this rotating exciter becomes the source of a magnetic flux sensed by the main winding of the stator 15 supplying power to the load or the line 18.

The regulator 17 is compatible with the various types of excitation commonly encountered in the industry.

The regulator 17 is more particularly shown in FIG. 9.

The operation of the regulator 17, notably the regulation and protection strategy together with ancillary functions, is provided by a main microcontroller 21 which executes a program in memory.

The power part 22 of the regulator 17 allows the current necessary to ensure a correct regulation to be supplied to the excitation inductor 11.

The microcontroller 21 receives measurements 25 and information coming from inputs and outputs 26 of the regulator 17.

The inputs and outputs 26 are dedicated to receiving and to sending analog or digital signals, without limitation on the number or on the function.

The measurements 25 relate mainly to the voltages and the currents, together where relevant with one or more ancillary sensors 19 such as temperature or rotation speed sensors. The microcontroller may receive, where relevant, information on equipment driving the shaft of the alternator, such as a thermal engine. This information allows the main microcontroller 21 to ensure not only a correct regulation of the voltage but also an adequate protection of the alternator. Recording of the data and of the events log may also be carried out in the regulator 17.

According to the invention, the electronic circuit of the regulator 17 comprises a communications module 23 connected to an antenna 24 via a matching circuit 27. This communications module 23 is equipped with a microcontroller which allows exchanges of data with the main microcontroller 21 to be undertaken.

In the present example, the regulator 17 comprises a printed circuit board 50, which can be seen in FIGS. 2 and 3, that carries most of the electronic components of the regulator 17 and, in particular, the communications module 23 and the antenna 24.

The communications module 23 communicates, via the antenna 24, with an interface module 4 having its own antenna 45 and whose electrical circuit diagram is given in FIG. 10.

The communications module 23 and interface module 4 are preferably communications modules using NFC technology.

The interface module 4 comprises, as illustrated in FIGS. 5 to 7, a printed circuit board 200 carrying a connector 201 defining a wired port, for example of the USB port type.

The board 200 is accommodated in a housing 202 comprising a lower outer shell 203 and an upper outer shell 204 that can be fixed onto the lower outer shell by snap-fit for example, by virtue of elastically deformable attachment feet 205.

The upper outer shell 204 has an opening 206 for the passage of the connector 201.

The board 200 carries the antenna 45, and the housing 202 is positioned on top of the board 50 in such a manner that the antennas 24 and 45 are substantially superposed.

The board 50 is accommodated within an outer shell 210, which forms for example the cradle of the regulator 17, and which has been shown on its own in FIG. 4.

On its bottom side, this outer shell 210 comprises 211 positioning lugs 212 on which the board 50 rests together with protrusions 214 guaranteeing correct alignment. The peripheral wall 217 of the outer shell, to which the lugs 212 are also connected, is extended at the top by a rim 218 directed toward the outside.

In the present example, the housing 202 is configured so as to be fixed onto the outer shell 210, and more particularly, onto its rim 218. This fixing is ensured by two studs 220 molded with the lower outer shell 203 and inserted into corresponding holes 223 formed on the rim 218. The end of the studs 220 protruding under the rim 218 may undergo a cold or hot deformation, depending on the materials used, in order to ensure that they are held on the outer shell 210.

Other techniques for fixing the housing of the module 4 onto the outer shell 210 and/or the board 50 may be used, such as for example snap-fitting, riveting, crimping, force fitting, soldering, adhesive bonding, screwing, slider mount.

In the example in FIG. 10, the module 4 is a simplified version allowing for example only the configuration of the regulator 17, for example by a computer, together with the observation of parameters in real time.

The unit 44 of the module 4 which provides the NFC function can receive the energy and data via the antenna 45 through a matching circuit 40 responsible for conditioning the electrical signals. The data and the energy can also come from a computer through an interface 41; in this case, the matching circuit may take the role of transforming this data into electrical signals interpretable by the antenna 24 of the regulator 17.

The interface 41 is preferably of the USB or RS232 type, but the use of another type of communications port remains within the scope of the present invention.

In the variant in FIG. 11, the module 4 incorporates an additional microcontroller 42 allowing the functions of the module 4 to be extended. For example, communications protocols of the CAN Bus J1939 or CANOpen type are implemented by virtue of this microcontroller, and also any other type of fieldbus. The interface 41 of this module 4 may be composed of one or more wired communications ports.

The invention offers the possibility of updating the firmware of the voltage regulator using the module 4.

Another functionality offered by the invention is the reading of the parameters of the digital voltage regulator via a telephone equipped with NFC technology and a dedicated application.

The regulator 17 is powered by a power supply which only delivers the required voltage when the alternator supplies sufficient voltage.

The board 50 may comprise an additional antenna 300, which is superposed on the antenna 24, and that the regulator 17 can selectively short-circuit for canceling the field from the module 4.

In particular, the antenna 300 is temporarily short-circuited, for a few ms, in order to carry out a clean transition between the state where the alternator does not deliver the voltage needed to correctly power the module 23, and in which the latter receives its energy from the module 4, and the state where the voltage supplied by the alternator is sufficient to ensure the operation of the module 23.

This allows the loss of communication between the regulator 17 and for example the computer connected to it via the module 4 to be managed, when switching to the power supply created using the voltages from the alternator.

The invention is not limited to the example that has just been described.

In particular, the module 4 may be fixed directly onto the board 50, for example

The invention is applicable to a rotating electric machine other than an alternator.

1. An electronic apparatus for a rotating electric machine comprising an electronic circuit and a wired bus allowing the exchange of information with the outside, wherein the bus is defined by an interface module rigidly attached to a board of the electronic circuit and communicating via a wireless link with the latter.

2. The apparatus as claimed in claim 1, the board being accommodated within an outer shell and the interface module comprising a housing fixed onto this outer shell.

3. The apparatus as claimed in claim 2, the housing of the interface module comprising pins engaged in corresponding holes of the outer shell.

4. The apparatus as claimed in claim 3, the holes being formed on a rim of the outer shell.

5. The apparatus as claimed in claim 1, the interface module communicating with a communications module of the apparatus, the board comprising an antenna connected to this communications module and the interface module comprising an antenna disposed facing the antenna of the board.

6. The apparatus as claimed in claim 5, the interface module and the communications module being of the NFC type.

7. The apparatus as claimed in claim 1, the interface module comprising a connector.

8. The apparatus as claimed in claim 1, comprising a main microcontroller whose DC electrical power supply is provided by a cable connected to the interface module or by the voltage produced by the machine equipped with the apparatus.

9. The apparatus as claimed in claim 1, the electric machine being an alternator and the apparatus being a regulator configured for transmitting to external equipment via the interface module, information coming from sensors connected to the alternator.

10. The apparatus as claimed in claim 1, the board comprising an additional antenna allowing, when short-circuited, the electromagnetic field sensed by the antenna used to exchange data with the interface module to be canceled.

11. Rotating electric machine, notably an alternator, equipped with an apparatus as claimed in claim 1.

12. A method for exchanging data with an electronic apparatus, equipping a rotating electric machine, such as defined in claim 1, for the configuring it, controlling it and recording information contained in the apparatus or updating the firmware of the apparatus, in which a computer is connected by means of a cable to the interface module and data is exchanged with the apparatus via the interface module.

13. The method as claimed in claim 1, the machine being an alternator and the apparatus a regulator, in which the additional antenna is short-circuited during a transient phase where the regulator receives the energy transmitted by the interface module connected to the computer and where the voltage of the alternator increases but is insufficient to take over from the power supply via the interface module.

14. The apparatus of claim 9, wherein the information coming from sensors being data relating to the temperature, the vibration, the current and the excitation voltage.
